(19) United States
(12) Patent Application Publication
(10) Pub. No.: US 2002/0125628 A1
(43) Pub. Date: Sep. 12, 2002

(54) Locating structure of a card-dispensing stop board of a card device

(76) Inventors: Pao-Jung Chen, Taichung (TW); Darrell G. Rademacher, New Port Richey, FL (US)

Correspondence Address: HARRISON & EGBERT, 412 MAIN STREET, 7TH FLOOR, HOUSTON, TX, 77002, US

(21) Appl. No.: 09/801,576

(22) Filed: Mar. 9, 2001

(51) Int. Cl. B65H 1/06; B65G 59/06

(52) U.S. Cl. 271/10.12; 271/165; 271/167; 221/258

(57) ABSTRACT

A card device comprises a card-dispensing stop board which is provided with two racks mounted thereon. The stop board can be adjusted in position by a gear shaft of the card device. The gear shaft is provided with two gears mounted on both ends thereof such that the two gears are meshed with the two racks of the stop board. The gear shaft is provided at one end with a rotary knob for actuating the gear shaft to drive the stop board to displace upward or downward.

### FIELD OF THE INVENTION

The present invention relates generally to a card device, and more particularly to a structure for locating the card dispensing stop board of the card device.

### BACKGROUND OF THE INVENTION

As shown in FIGS. 1-4, a card device of the prior art has a main body 10 which is provided with two side boards 11 and 12, and a receiving chamber 13 located between the two side boards 11 and 12 for disposing a variety of cards 1. The receiving chamber 13 is provided at the front side with a bottom board 14 held by the two side boards 11 and 12 and is further provided at the top with a stop board 15 having two folded sides 151 and 152. The two folded sides 151 and 152 are provided with an upper locating rod 16 and a lower locating rod 17. The upper locating rod 16 has two ends which are opposite to two upper long slots 111 and 121 of the two side boards 11 and 12. Two bolts 18 and 19 are engaged with two ends of the upper locating rod 16 via the two long slots 111 and 121. The lower locating rod 17 has two ends, which are inserted into the lower long slots 112 and 122 of the two side boards 11 and 12, thereby locating the stop board 15 between the two side boards 11 and 12. Now referring to FIGS. 5,6, and 7, the two bolts 18 and 19 of two ends of the upper locating rod 16 can be loosened to enable the stop board 15 to be manually adjusted upward or downward such that the bottom edge of the stop board 15 and an outlet 2 of the underside of the bottom board 14 can be adjusted in height accordance with the thickness of the cards 1, so as to facilitate the dispensing of the cards 1.

Such prior art card device as described above is defective in design in that the stop board 15 is not properly located. As described above, the stop board 15 is located by means of the two blots 18 and 19 of two ends of the upper locating rod 16. If the cards 1 are different in thickness, the height of the outlet 2 located between the stop board 15 and the bottom board 14 must be adjusted accordingly. In other words, each time when the cards I of a specific thickness are held in the card device, the height of the outlet 2 must be adjusted accordingly by loosening the two blots 18 and 19 of two ends of the upper locating rod 16 so as to adjust the stop board 15 upward or downward. Thereafter, the two blots 18 and 19 must be tightened again. In light of the card device being mounted in the interior of a specific vending machine, the frequent adjustment of the stop board 15 causes a great deal of inconvenience and annoyance.

### SUMMARY OF THE INVENTION

The primary objective of the present invention is -to provide a card device with a card-dispensing stop board which is free of the deficiencies of the stop board of the prior art card device described above.

The card device of the present invention comprises a card-dispensing stop board and two gears mounted on two ends of a shaft. The stop board is provided with two racks which are engaged with the two gears. The stop board is adjusted by actuating the shaft on which the two gears are mounted.

The objective, features and functions of the present invention will be more readily understood upon a thoughtful deliberation of the following detailed description of the present invention with reference to the accompanying drawings.

### BRIEF DESCRIPTION OF THE DRAWINGS

FIG. 1 shows a perspective view of a card device of the prior art.

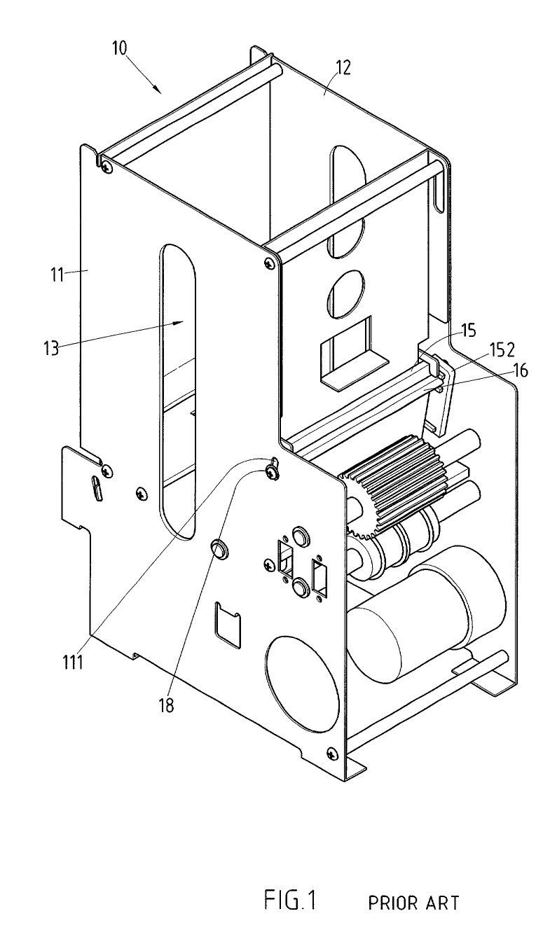

FIG. 2 shows a partial exploded view of the card device of the prior art.

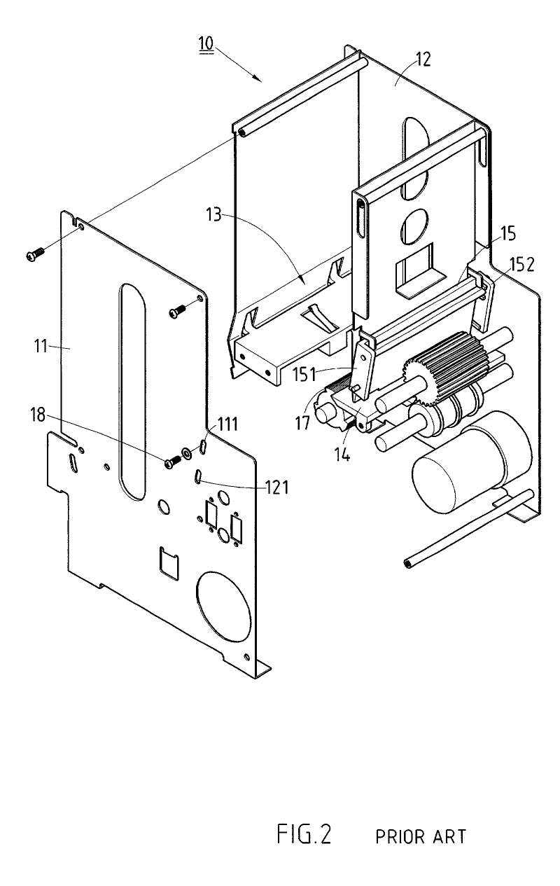

FIG. 3 shows another partial exploded view of the card device of the prior art.

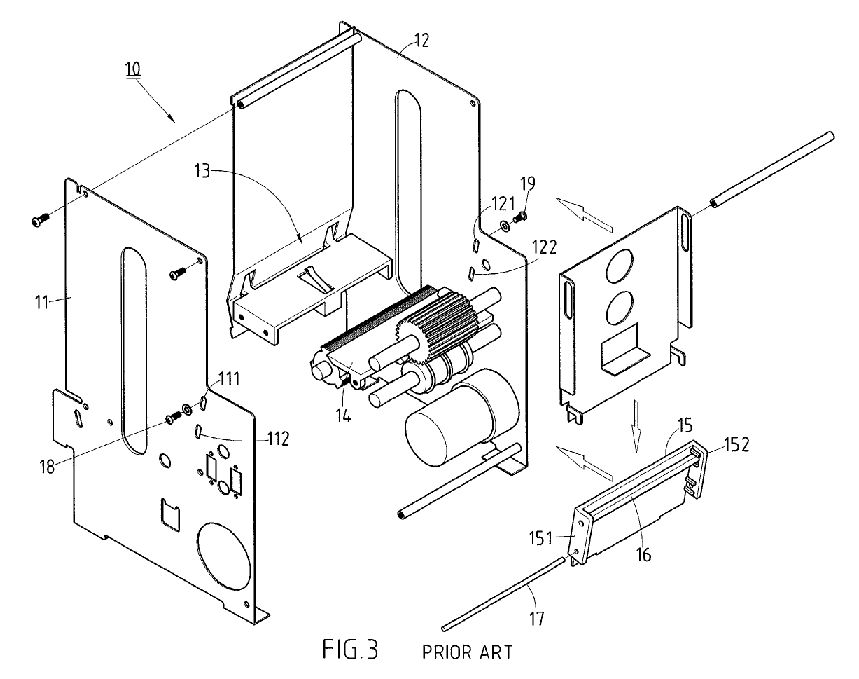

FIG. 4 shows a side sectional view of the card device of the prior art.

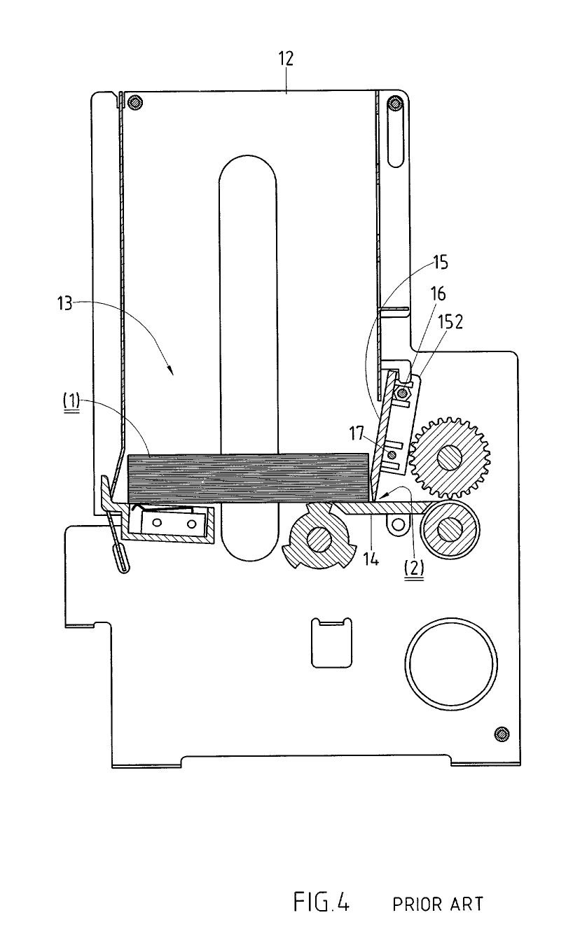

FIG. 5 shows a front sectional view of the stop board and two side boards of the card device of the prior art.

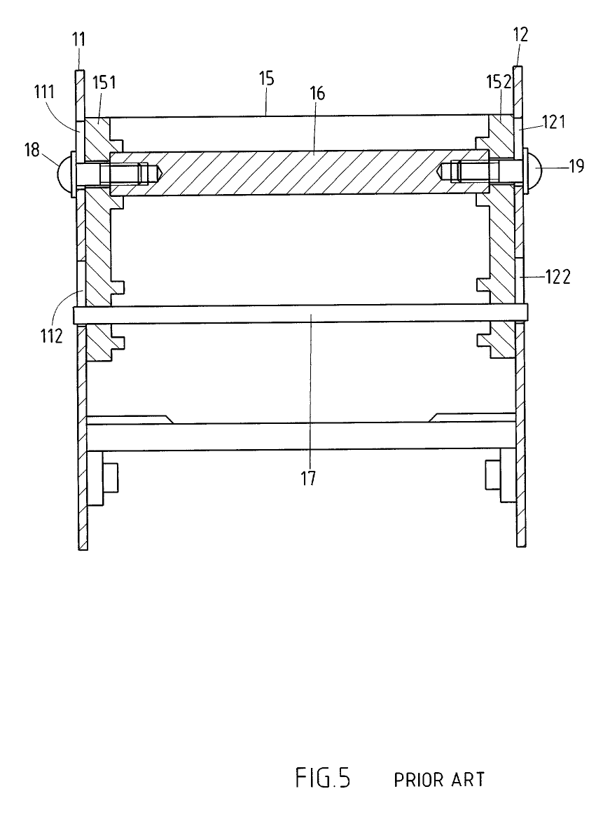

FIG. 6 shows a side sectional view of the stop board of the card device of the prior art in action.

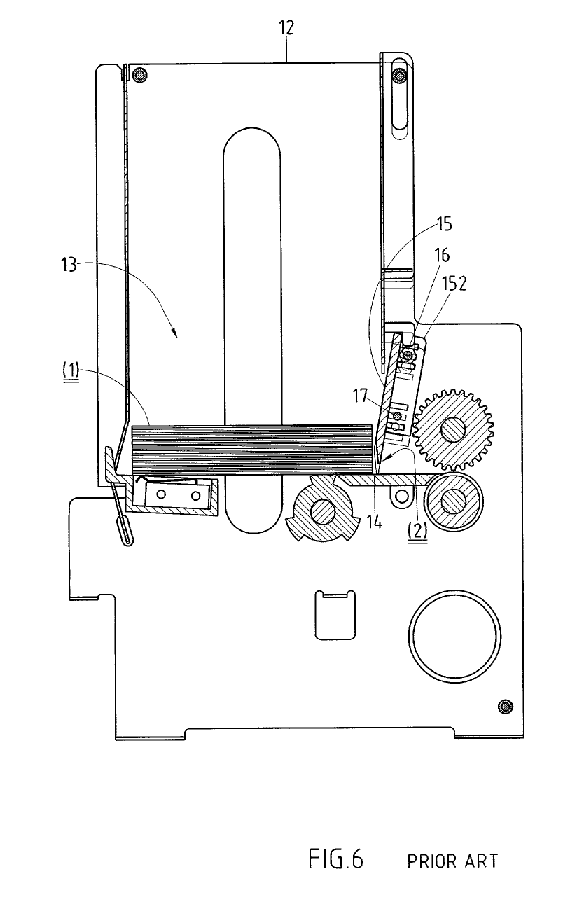

FIG. 7 shows a front sectional view of the stop board of the card device of the prior art in action.

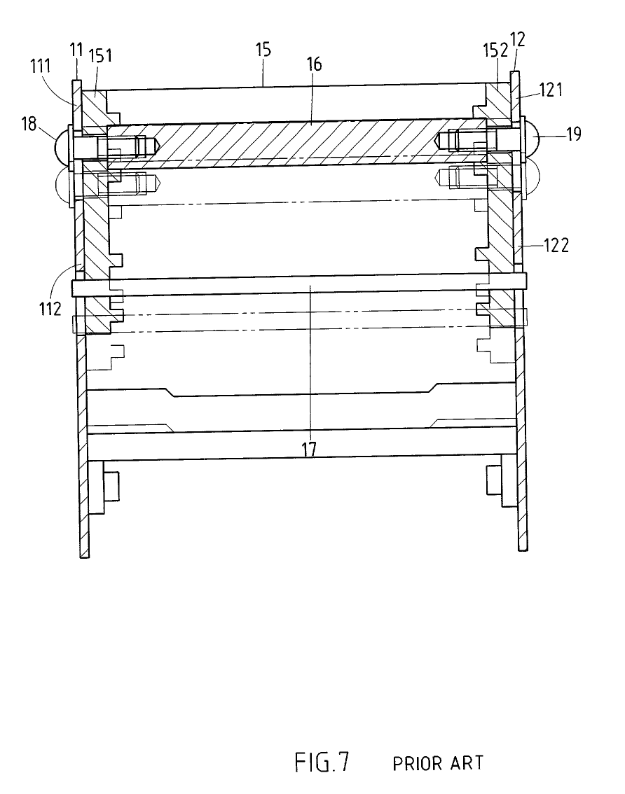

FIG. 8 shows a perspective view of the present invention.

FIG. 9 shows a partial exploded view of the present invention.

FIG. 10 shows another partial exploded view of the present invention.

FIG. 11 shows a side sectional view of the present invention.

FIG. 12 shows a front sectional view of the stop board and the two side boards of the present invention.

FIG. 13 shows a front sectional view of the stop board of the present invention in action.

### DETAILED DESCRIPTION OF THE INVENTION

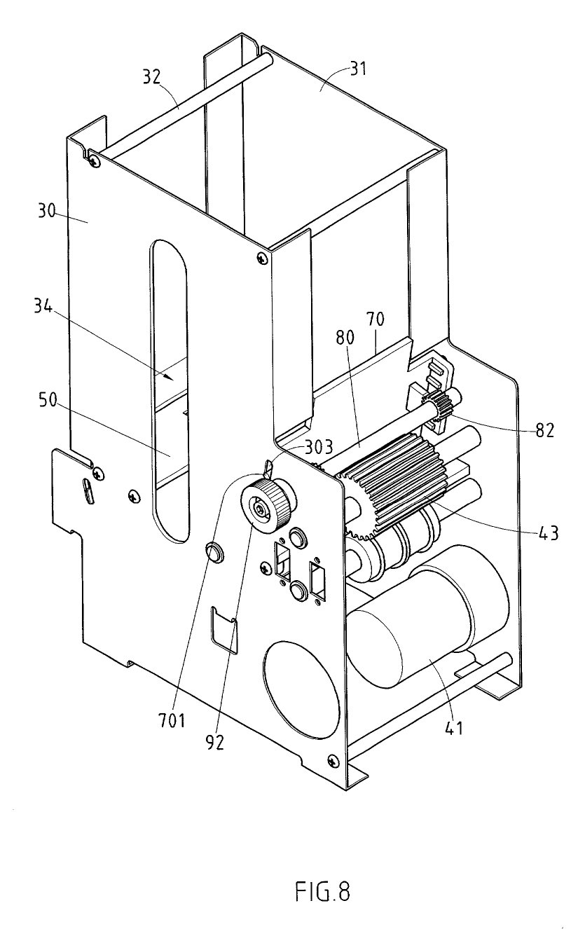

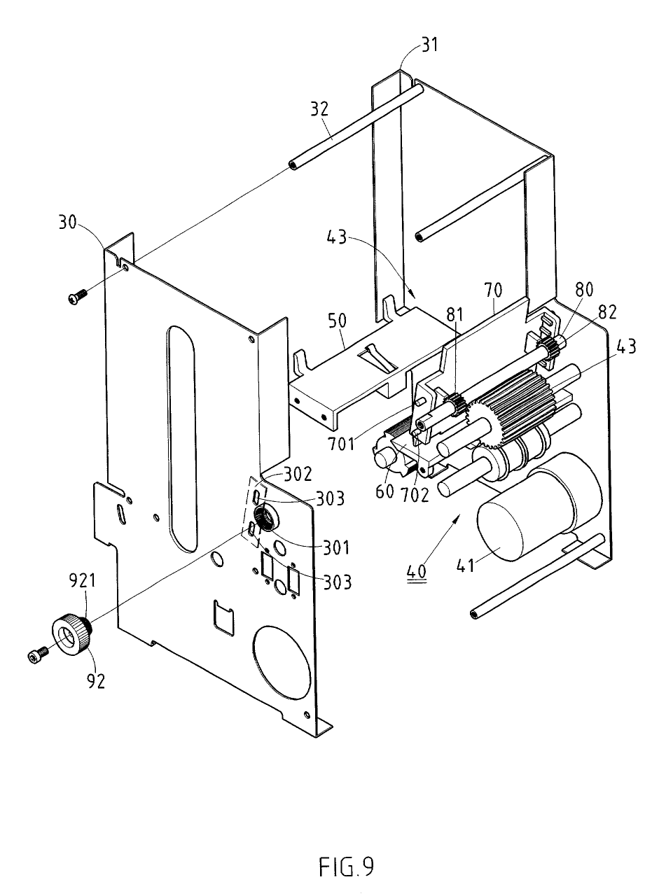

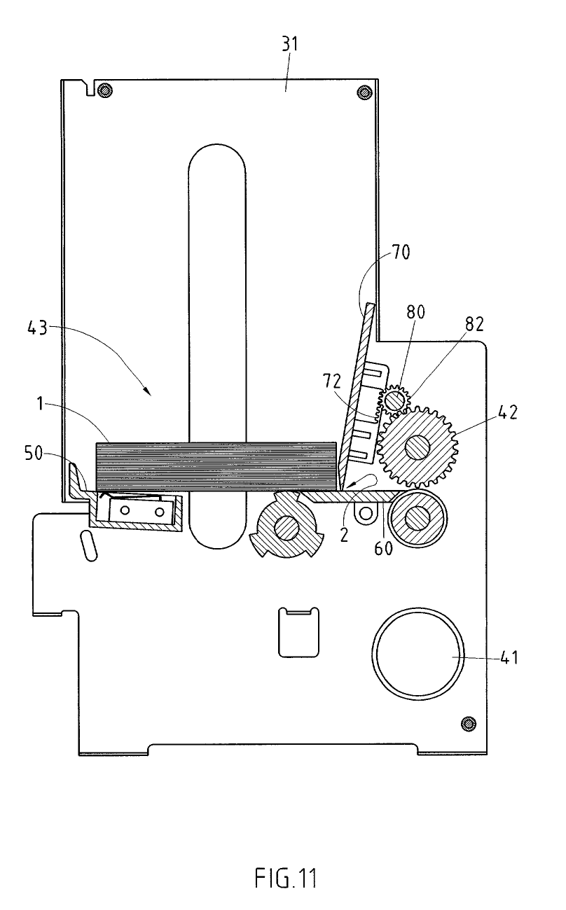

As shown in FIGS. 8-11, a card device of the present invention comprises the component parts which are described hereinafter.

Two side boards 30 and 31 are parallel to each other and are fastened by a plurality of horizontal rods 32 in conjunction with a plurality of fastening screws 33.

A transmission member 40 is formed of a motor 41, a plurality of gears 42, and a plurality of rollers 43. The transmission member 40 is mounted on the second side board 31.

A rear bottom board 50 is located between the inner sides of the two side boards 30 and 31.

A front bottom board 60 is located between the inner sides of the two side boards 30 and 31 such that the front bottom board 60 is opposite in location to the rear bottom board 50, and that the tops of the rear bottom board 50 and the front bottom board 60 are flush, and further that the front bottom board 60 defines a receiving chamber 34 along with the rear bottom board 50 and the two side boards 30 and 31.

A stop board 70 is disposed slantingly between the opposite inner sides of the two side boards 30 and 31 such that the bottom edge of the stop board 70 is opposite to the top of the front bottom board 60. The stop board 70 is characterized by two longitudinally-oriented racks 71 and 72, which are mounted on the front side of the stop board 70 and are located in proximity of the two side boards 30 and 31.

A gear shaft 80 is pivotally fastened between the two side boards 30 and 31 such that the gear shaft 80 is opposite in location to the front side of the stop board 70. The gear shaft 80 is provided at two ends with gears 81 and 82, which are respectively engaged with the racks 71 and 72 of the stop board 70.

The gear shaft 80 has “A” and 801, which is put through the second side board 31 and is fitted into a spring 90 along with a C-shaped retainer 91. One end of the spring 90 urges the outer side of the second side board 31, whereas other end of the spring 90 urges the inner side of the C-shaped retainer 91. The gear shaft 80 has “B” end 802 which is put through the first side board 30 to engage a rotary knob 92. The rotary knob 92 is provided in the inner side with a threaded projection 921, which is engaged with a threaded recess 301 of the first side board 30.

The stop board 70 is further provided in two sides with an upper pillar 701 and a lower pillar 702. The two side boards 30 and 31 are provided in the inner side with a guide slot 302, 311. The guide slots 302 and 311 have respectively an upper retaining hole 303, a lower retaining hole 312. The stop board 70 is located by the two side boards 30 and 31 such that two sides of the stop board 70 are inserted into the guide slots 302 and 311, and that the upper pillar 701 and the lower pillar 702 of the stop board 70 are received in the upper retaining hole 303 and the lower retaining hole 312 of the two side boards 30 and 31.

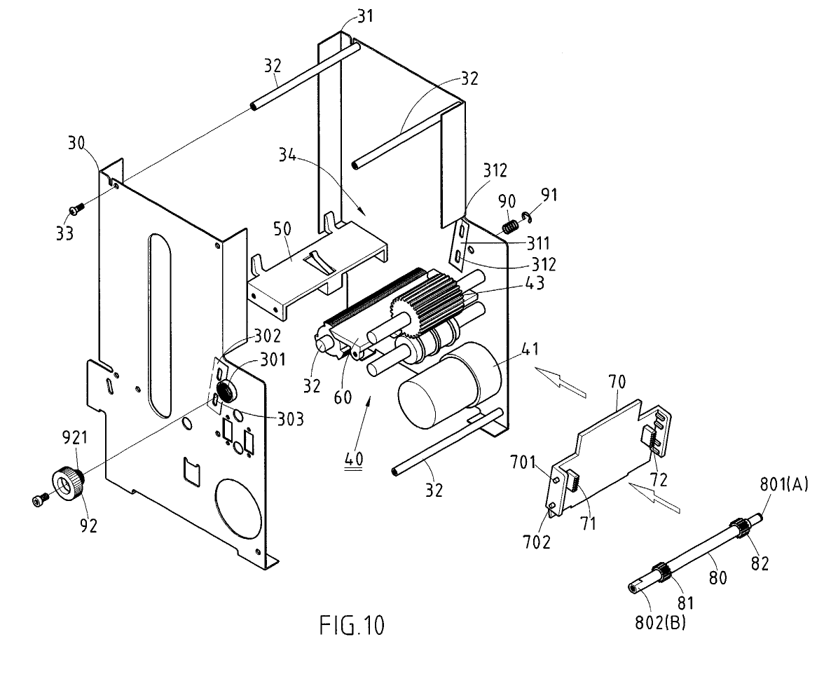

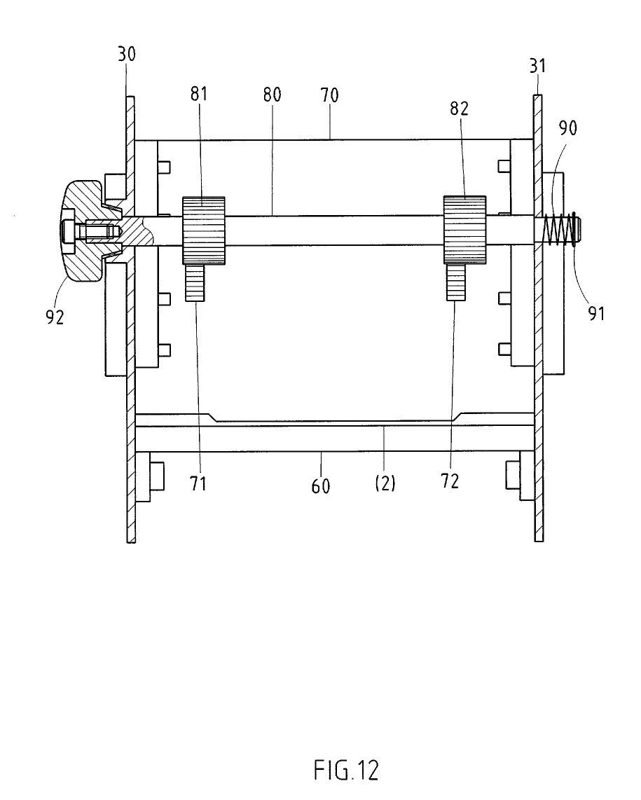

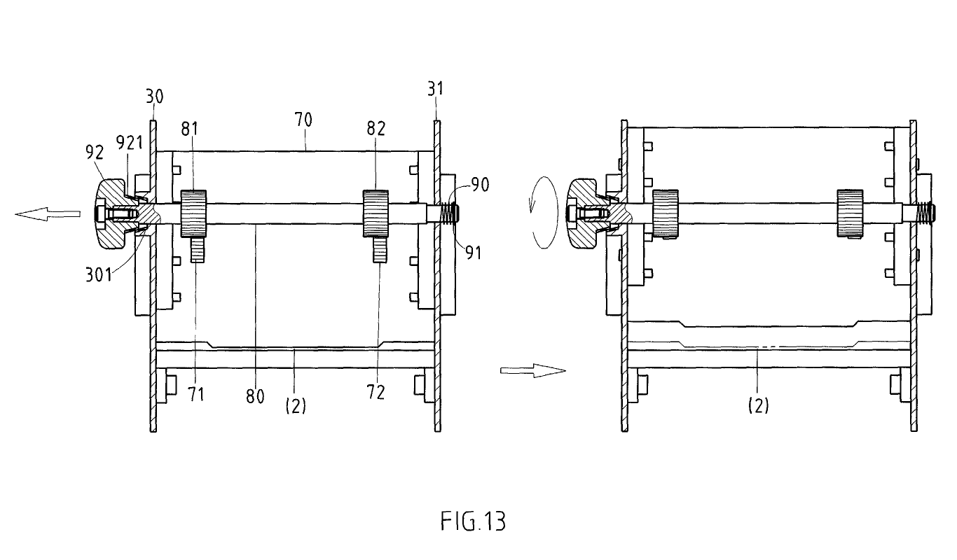

As illustrated in FIGS. 10-13, the outlet 2 of the card device of the present invention is adjusted in height by pulling the rotary knob 92 of the gear shaft 80 so as to cause the spring 90 of the A end 801 of the gear shaft 80 to compress, thereby resulting in disengagement of the threaded projection 921 of the rotary knob 92 with the threaded recess 301 of the first side board 30. In the meantime, the gear shaft 80 can be actuated by the rotary knob 92 to turn radially such that the gears 81 and 82 actuate the racks 71 and 72 of the stop board 70, thereby resulting in an upward displacement or downward displacement of the stop board 70. Upon completion of the height adjustment of the outlet 2, the rotary knob 92 is let go such that the recovery force of the spring 90 drives the gear shaft 80 to displace toward the second side board 31, and that the threaded projection 921 of the rotary knob 92 is engaged with the threaded recess 301 of the first side board 30. In addition, the gear shaft 80 is fixed by the rotary knob 92 such that the gear shaft 80 can not be radially turned.

The stop board 70 is displaced upward or downward with a great deal of stability in view of the fact that the upper pillar 701 and the lower pillar 702 of the stop board 70 are confined in the upper retaining hole 303 and the lower retaining hole 312 of the two side boards 30 and 31.

I claim:

1. A locating assembly of a card-dispensing stop board of a card device, said locating assembly comprising:
a first side board and a second side board fastened with said first side board by a plurality of horizontal rods and fastening screws;
a transmission member formed of a motor, a plurality of gears, and a plurality of rollers, said transmission member being mounted on said second side board;
a rear bottom board disposed between two opposite inner sides of said first side board and said second side board;
a front bottom board disposed between two opposite inner sides of said first side board and said second side board such that said front bottom board is opposite in location to said rear bottom board, and that a top of said front bottom board is flush with a top of said rear bottom board, and further that said front bottom board forms and defines a receiving chamber along with said rear bottom board, said first side board, and said second side board;
a stop board disposed between opposite inner sides of said first side board and said second side board such that a bottom edge of said stop board is opposite to the top of said front bottom board, and that said stop board is provided with two racks mounted thereon; and
a gear shaft fastened pivotally between said first side board and said second side board such that said gear shaft is opposite in location to a front side of said stop board, and that said gear shaft is provided at two ends thereof with a gear mounted thereon, said two gears of the two ends of said gear shaft being respectively engaged with two racks of said stop board whereby said gear shaft has one end which is put through said second side board and is fitted into a spring in conjunction with a C-shaped retainer, with one end of said spring urging the outer side of said second side board, and with other end of said spring urging the inner side of said C-shaped retainer, said gear shaft having other end which is put through said first side board to engage a rotary knob, said rotary knob being provided in an inner side with a threaded projection which is engaged with a threaded recess of said first side board.

2. The locating assembly as defined in claim 1, wherein said stop board is provided in two sides thereof with an upper pillar and a lower pillar; wherein said first side board is provided in the inner side with a first guide slot having an upper retaining hole; wherein said second side board is provided in the inner side with a second guide slot having a lower retaining hole; wherein said stop board is located by said first side board and side second side board such that two sides of said stop board are received in said first guide slot and said second guide slot, and that said upper pillar of said stop board is received in said upper retaining hole, and that said lower pillar of said stop board is received in said lower retaining hole.
